(19) United States
(12) Patent Application Publication
(10) Pub. No.: US 2006/0288971 A1
(43) Pub. Date: Dec. 28, 2006

(54) Engine in box shape

(76) Inventors: Ylli Tasi, Tirana (AL); Hektor Tasi, Tirana (AL)

Correspondence Address: HEKTOR TASI, K.VERSI 2 PANGRATI, ATHENS, 11635, GR

(21) Appl. No.: 11/166,360

(22) Filed: Jun. 27, 2005

(51) Int. Cl. F02B 75/18

(52) U.S. Cl. 123/56.1

(57) ABSTRACT

New Engine in Box Shape is made up of four cylinders arranged in one plane, in opposition, with their axes two by two coaxial and parallel, the motor main shaft (2) arranged between two cylinders C1 and C2, the obelisk (6), pivoted both at the eccentric pivot (3) and at the central shaft (5), which in its two extremities pivot the connecting-rods (8) with the pistons (9), and of the heads (11) endowed with the camshafts (10) located vertically to the motor main shaft (2). When the pistons (9) are set in motion, as in case of internal combustion engines, their alternative straight-line motion is transformed in rotative motion of the motor main shaft (2) and vice-versa for the case of the compressors.

### CROSS-REFERENCE TO RELATED APPLICATION

This invention consists in the constructive changes made in the mechanism to transform the alternative straight-line motion of the pistons into rotating motion of the motor main shaft, in the arranging the camshafts and the way of transmitting motion to them, in the pattern of arranging the cylinders etc, applied in the International Patent “Piston Driven Axial Cylinder Engine”, U.S. Pat. No. 5,992,357 Dt Nov. 30, 1999 and inventor Ylli Tasi, for the specific case of an aggregate of four cylinders arranged in a plane.

### STATEMENT REGARDING FEDERALLY SPONSORED RESEARCH OR DEVELOPMENT

Not applicable

### REFERENCE TO A SEQUENCE LISTING A TABLE OR A COMPUTER PROGRAM LISTING COMPACT DISC APPENDIX

Not applicable

### BACKGROUND OF THE INVENTION

This invention pertains to the field of the aggregates working with pistons, as are the internal combustion engines, compressors and hydraulic pumps. Concretely this is an engine with four cylinders arranged in a plane, in opposite way, their axes two by two coaxial and parallel, with a motor main shaft arranged in the middle of two cylinders, its axis being parallel to the cylinder axes, the camshafts having their axes stretched in the plane of the cylinder axes but perpendicular to the motor main shaft axis, and with a shaft called central, pivoted in its middle and its axis always stretched in the plane of the cylinder axes, which transforms the alternative straight-line motion of the pistons in rotating motion of the motor main shaft and vice-versa.

### BRIEF SUMMARY OF THE INVENTION

A cylinder block in box shape is made up of four cylinders arranged oppositely in a plane, with their axes two by two parallel and coaxial. In the middle of the two first cylinders that have their axes parallel, it is arranged a motor main shaft with its axis stretched in the plane of the cylinders, parallel to them and in equal distance from them. This motor main shaft, in its lower end, and with a determined eccentricity, has an eccentric pivot.

In the middle of the four cylinders and in the prolongation of the motor main shaft axis, is arranged a pin called central, which has its axis perpendicular to the plane formed by the axes of the cylinders. The intersecting point of this central pin axis with the prolongation of the motor main shaft axis, will be called center of the cylinder block.

In the central pin is pivoted a shaft called central, in a way its axis pass through with the center of the cylinder block and its axis stretch in the plane of the cylinder axes. In the central shaft, by the two sides of the central pin, is pivoted an obelisk by means of two rings this has In its base. The free top of the obelisk, of a pin shape, is pivoted in the eccentric pivot of the motor main shaft in a way that their axes coincide and pass through the cylinder block center.

In both the extremities of the motor main shaft, and corresponding to the cylinder axes, are pivoted the connecting rods. The connecting rods can be one for each piston and be pivoted by means of pins as usually, or an only connecting rod for each two pistons. In this case, the connecting-rod and the two pistons form one body, coaxial and rigid, whose pivoting center is in its middle.

Seeing the construction of this mechanism from a kinetic point of view, we observe that the axes of the motor main shaft, of the central shaft, of the central pin, and the two perpendicular axes of the obelisk intersect altogether in one point that is the center of the cylinders block. Along with the rotating of the motor main shaft, as in the case of compressors, the center of the eccentric pivot, which at the same time is the center of the obelisk top pin, carries out a circular trajectory, whose center is located at the motor main shaft axis, whereas the axis of the obelisk top pin describes a cone whose apex is the cylinder block center. The obelisk itself will do a combined motion, compelling the central shaft to do a rotating motion of alternate sense around the axis of the central pin, whereas the pivoting centers at the central shaft do an alternative trajectory of circle arc sector and the pistons inside the cylinders the alternative straight line motion with a calculated course.

In case of internal combustion engine aggregates, we have the inverse sense of motion, i.e. the alternative straight line motion of the pistons, by now active, is transformed into rotating motion of the motor main shaft. The forced command of the valves is realized by arranging the camshafts in the cylinder heads in a way that their axes stretch in the plane of the cylinder axes and be perpendicular to the motor main shaft axis. The camshafts of the two first cylinders take their motion by means of gears directly from the motor main shaft, while the camshafts of the two opposite cylinders take their motion from the camshafts of the two first cylinders.

In case of construction of aggregates with two or more cylinder blocks (or with 8, 12, 16 cylinders) the arranging of the cylinder blocks is done: either in one plane, having the axes of the respective cylinders coaxial, or in two planes, having the cylinder axes parallel, or in a combined way. In all cases, it is arranged an intermediate shaft, which is geared with the motor main shafts of each block, in order to transmit their motion and power.

In case of compressor aggregates, in order to avoid the phenomenon of mixture of compressed air or gas with lubricant vapours, we apply the straight line motion of the connecting-rod, which gives possibility to arrange diaphragms with sealing grooves in the end of each cylinder.

Aggregates constructed according the above description have a series of advantages. The abolition of the crankshaft as a difficult detail with together the all negative consequences deriving from its use, gives simpler constructions with less costly production technology, as well as a more favorable dynamics, being the friction forces piston/cylinder largely smaller and given the possibility of changing the nature of friction from sliding into rolling (by arranging ball-bearings in all pivoting knuckles).

### BRIEF DESCRIPTION OF THE SEVERAL VIEWS OF THE DRAWING

The invention will now be described by way of some examples presented in the respective drawings:

FIG. 1 shows the way of arranging the cylinders, the mechanism of transforming the motion and the transmission of motion to the camshafts in an internal combustion engine.

FIG. 2 shows the intermediate shaft and the transmission of motion in an engine of two cylinder blocks arranged in two parallel planes.

FIG. 3 shows the intermediate shaft and the way of transmitting the motion in an engine of two cylinder blocks arranged in a plane.

FIG. 4 shows the arranging of the diaphragms with sealing grooves in a compressor of four individual cylinders.

### DETAILED DESCRIPTION OF THE INVENTION

### FIRST EXAMPLE

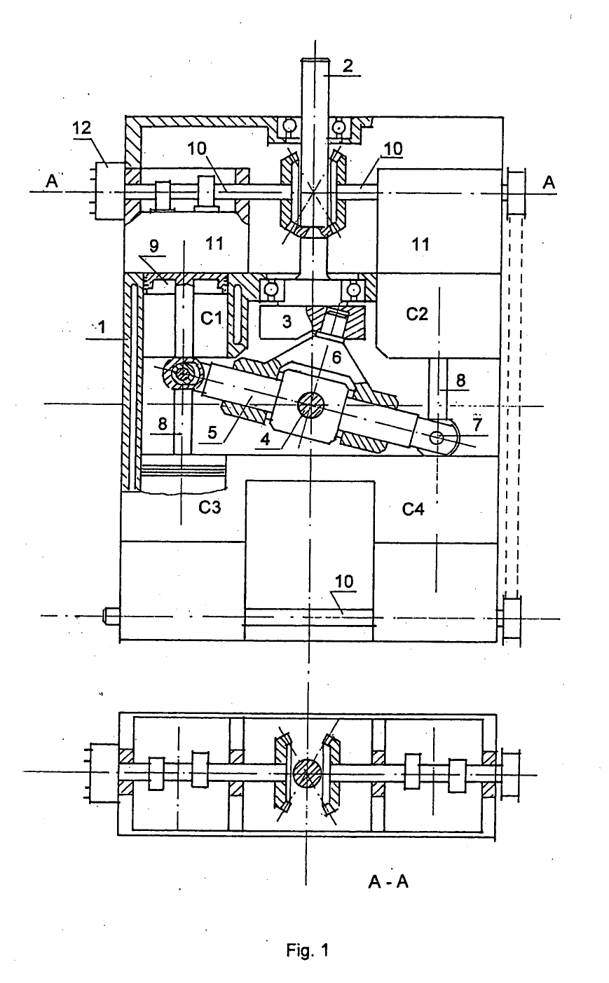

A box-engine of four cylinders arranged in a plane. FIG. 1

The cylinder block (1) is made up of four cylinders (C1, C2, C3, C4) arranged in a plane in opposite way, with the cylinder axes two by two coaxial and parallel. In the middle of the two first cylinders (C1 and C2), which have their axes parallel, it is arranged the motor main shaft (2), which has its axis in the same plane, parallel to them and equidistant from them. The motor main shaft (2) in its lower end has the eccentric pivot (3).

In the center of the cylinder block and in a perpendicular way, it is arranged the central pin (4). In this central pin (4) it is pivoted the central shaft (5) in at its middle, in a way that its axis stretch in the plane of the cylinder axes and intersect the central pin (4) axis in the cylinder block center.

The obelisk (6), by means of two rings it has in its base, is pivoted at the central shaft (5), whereas its free top of a pin shape, is pivoted at the eccentric pivot (3) of the motor main shaft (2).

The central shaft (5) in its two ends has the pivoting knuckles (7) in which there are pivoted the connecting-rods (8).

The camshafts (10), arranged in the cylinder heads (11) have their axes perpendicular to the motor main shaft (2) axis, and stretch in the plane of the cylinder axes. The camshafts (10) of the two first cylinders (C1 and C2) take their motion directly from the motor main shaft (2), by means of the conic gears in a transmission ratio 1/2. The camshafts (10) of the two opposite cylinders (C3 and C4) take motion from the camshafts of the cylinder C2. In the same way take motion the other auxiliary equipments too. The distributor or the naphtha pump (12) is set in motion directly by the camshaft (10) of the cylinder C1. Setting in phase the camshafts (10) in relation to the pistons (9), we will have a firing order 1-2-4-3 or 1-3-4-2, with a burst per 720°:4=180°.

The application of these engines in automobiles gives the vehicle a lowering of the weight center, a better stability in going and sufficient empty room for accessories.

### SECOND EXAMPLE

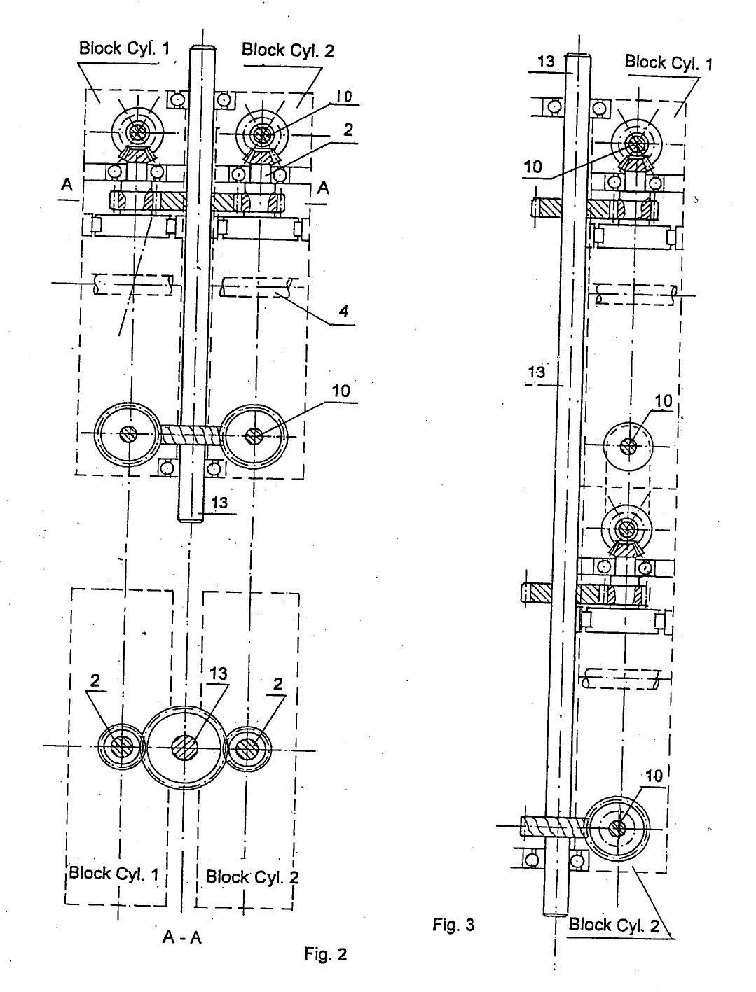

Engine of two cylinder blocks arranged in two parallel planes. FIG. 2

In this example the two cylinder blocks are arranged in two parallel planes and have the cylinder axes parallel. The two motor main shaft (2) are shorter in order to be possible the continuity of the camshafts (10). Each motor main shaft (2) has between its two supports a gear. Between the two motor main shafts (2) and parallel to them, it is arranged the intermediate shaft(13),which by means of its gear, gears to the gears of the two motor main shafts(2),taking from them half of the revolutions and the function of the main shaft. The camshafts (10) of the cylinders C3 and C4 are made one body with an oblique gear. The two oblique gears of the four camshafts (10), which are in one plane, gear with the gear of the intermediate shaft (13).

By gearing the two motor main shafts (2) with the intermediate shaft (13) in order between the two motor main shafts (2) to be a dis-phase of 90°, and setting in phase the camshafts (10) in relation to the pistons, we will have a firing order 1-5-2-6-4-8-3-7 or 1-5-3-7-4-8-2-6 with a burst each 720°:8=90°.

The addition of two or four cylinder blocks and the extension of the intermediate shaft (13) will provide engines with 16 or 24 cylinders arranged in two parallel planes.

### THIRD EXAMPLE

Engine of two cylinder blocks arranged in a plane. FIG. 3

The engine of this example is made up of two cylinder blocks arranged in a plane. The cylinders axes of two blocks fit, as well as those of the two motor main shafts (2).

In this example are applied three ways of motion transmission to the camshafts (10): Transmission of motion by the motor main shafts (2), transmission of motion between the camshafts (10) and transmission of motion by the intermediate shaft (13).

By setting in phase the motor main shafts (2), the intermediate shaft (13) and the camshafts (10) we will produce a firing order 1-5-2-6-4-8-3-7 or 1-5-3-7-4-8-2-6, with a burst per 90°.

The addition of another cylinder block and the extension of the intermediate shaft (13) will provide an engine of 12 cylinders arranged in a plane.

### FOURTH EXAMPLE

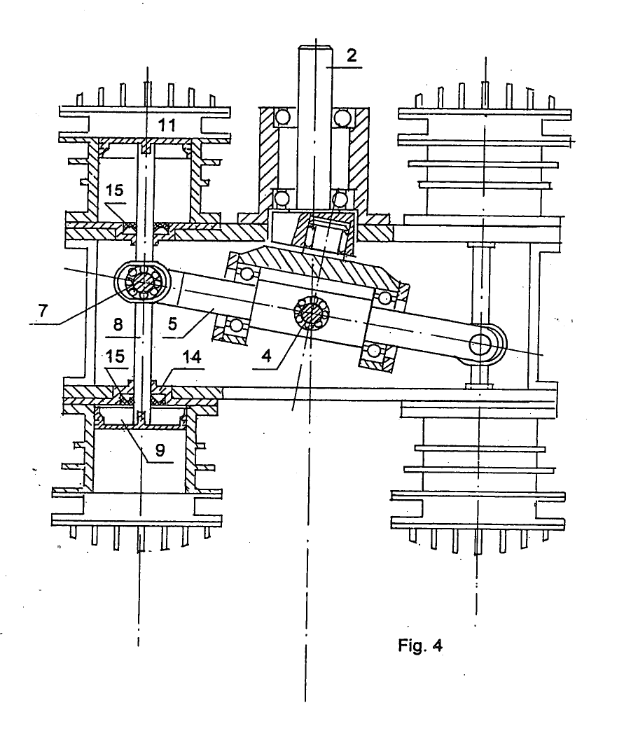

Compressor of four individual cylinders FIG. 4

The compressor of this example is made up of four cylinders (C) together with the heads (11) and the motion mechanism. In order to avoid the phenomenon of mixture of the compressed air or gas with the lubricant vapours, in the end of each cylinder are arranged the diaphragms (14) endowed with sealing grooves (15). In order to provide an alternative straight-line notion of the connecting-rod (8) in accord with the cylinder axes (C), is chosen the variance “one connecting-rod for two pistons”, which form one coaxial body. The connecting-rod (8) has the pivoting nest in the middle; its two ends, where work the sealing grooves, are of tube shape, of a circular section.

Keeping in view the trajectory of the two pivoting centers, that of the connecting-rod (8), which does an alternative straight-line motion after the cylinder axis, and that of the central shaft (5) with an alternative trajectory of circle arc sector that has for center the center of the cylinder block, is chosen for their pivoting the ball-bearing type pivot. The ball-bearing mounted at the pin (7) of the central shaft (5) has the freedom to roll in the pivot nest of the connecting-rod (8). There is also an advantage: the constructive possibility to arrange shut ball-bearings (with sealing grooves) in all the pivoting knuckles. In case of constructing a compressor of two cylinders, we abolish two opposite cylinders and their pistons together with a part of the connecting-rod. In this case the two diaphragms with the sealing grooves take too the guide function of the connecting-rods.

1. New Engine in Box Shape comprising,
a block of four cylinders in box shape, where the above-said cylinders are arranged in a plane, in opposition, with their axes parallel and two by two coaxial, a motor main shaft arranged in the middle of the two cylinders, with its axis parallel, equidistant and stretched in one plane with the cylinder axes, and a central pin, which has its axis perpendicular to the plane of the cylinder axes and intersected with the prolongation of the motor main shaft axis in the point called center of the cylinder block,
In the above-said central pin is pivoted a central shaft in its middle, in a way that its axis pass through the cylinder block center and stretch in the plane of the cylinder axes,
In the above-said central shaft, in both its extremities, are pivoted the connecting-rods, and in its middle, in both sides of the central pin, an obelisk,
The above-said obelisk, by means of two rings it has in its base, is pivoted at the central shaft, whereas its top, of pin shape, is pivoted at an eccentric pivot, located in the motor main shaft,
The above-said cylinders, by one side are shut with the cylinder heads, endowed with camshafts,
The above-said camshafts are perpendicular to the motor main shaft, whence they take their motion,
In case of aggregates of two or more cylinder-blocks, it is arranged an intermediate shaft, which is parallel with the motor main shafts and geared with them,
In case of compressor-aggregates, in order to avoid the mixing of compressed air or gas with the lubricant vapours, are arranged diaphragms with sealing grooves at the end of each cylinder.

2. New Engine in Box Shape, according to claim 1, in case is applied one connecting-rod for two pistons, the connecting-rod and the two pistons are made one body, coaxial and rigid, which has its pivoting center in the middle.

3. New Engine in Box Shape, according to claim 1, the camshafts and the auxiliary equipments can be set in motion by the motor main shaft, by the intermediate shaft and by the camshafts themselves.

4. New Engine in Box Shape, according to claim 1, when the aggregates are made up of two or more cylinder blocks, arranged in two parallel planes, the cylinders are arranged so to have their axes coaxial, parallel and stretched in two parallel planes.

5. New Engine in Box Shape, according to claim 1, when the aggregates are made up of two or more cylinder blocks arranged in one plane, the cylinders are arranged so to have their axes coaxial, parallel and stretched in one plane.
